(19) United States
(12) Patent Application Publication
(10) Pub. No.: US 2023/0271283 A1
(43) Pub. Date: Aug. 31, 2023

(54) COMPRESSED FLUID SUPPLY SYSTEM

(71) Applicant: FANUC CORPORATION, Minamitsuru-gun, Yamanashi (JP)

(72) Inventor: Masahiro MUROTA, Minamitsuru-gun, Yamanashi-ken (JP)

(73) Assignee: FANUC CORPORATION, Minamitsuru-gun, Yamanashi (JP)

(21) Appl. No.: 18/016,163

(22) PCT Filed: Jul. 12, 2021
(86) PCT No.: PCT/JP2021/026062

§ 371 Date: Jan. 13, 2023

(30) Foreign Application Priority Data
Jul. 17, 2020 (JP) 2020-122822

(51) Int. Cl. B23Q 1/38; F16C 32/06

(52) U.S. Cl. CPC B23Q 1/38; F16C 32/06

(57) ABSTRACT

A compressed fluid supply system comprises: a pressure adjustment unit for adjusting the pressure of a compressed fluid supplied from a fluid supply source to support members supporting a movable member so that the movable member can be driven through the use of the compressed fluid; a drive force acquisition unit for acquiring a drive force of a motor for driving the movable member; and a pressure control unit for adjusting the pressure of the compressed fluid supplied to the support members by controlling the pressure adjustment unit on the basis of the drive force of the motor.

### TECHNICAL FIELD

The present invention relates to a compressed fluid supply system that supplies a compressed fluid to a support member that supports a movable member in a drivable manner.

### BACKGROUND ART

There is used a drive unit that supports and drives a movable member by a static pressure bearing. For example, such a static pressure bearing is provided for a spindle of a machine tool. The static pressure bearing rotatably supports the movable member of the spindle with respect to the fixed member of the spindle.

JP 2017-210991 A discloses an abnormality detection device for a fluid bearing that detects occurrence of clogging in a flow path to the bearing by using a pressure sensor.

### SUMMARY OF THE INVENTION

Here, for achieving an appropriate processing (for example, machining by a machine tool), it is preferable to adjust the rigidity of the static pressure bearing that supports the movable member in accordance with the driving state of the movable member. By adjusting the rigidity, for example, the machine tool can appropriately cope with both rough machining and finish machining. However, in the technique of JP 2017-210991 A, it is not assumed that the rigidity of the static pressure bearing supporting the movable member is adjusted.

An object of the present invention is to provide a compressed fluid supply system capable of adjusting rigidity for supporting a movable member, in accordance with a driving state of the movable member.

According to an aspect of the present invention, there is provided a compressed fluid supply system including: a pressure adjustment unit configured to adjust a pressure of a compressed fluid that is supplied from a fluid supply source to a support member, the support member being configured to support a movable member so as to be drivable using the compressed fluid; a driving force acquisition unit configured to acquire a driving force of a motor configured to drive the movable member; and a pressure control unit configured to control the pressure adjustment unit to thereby adjust the pressure of the compressed fluid supplied to the support member, based on the driving force of the motor.

According to the present invention, it is possible to provide a compressed fluid supply system capable of adjusting rigidity for supporting a movable member, in accordance with a driving state of the movable member.

### BRIEF DESCRIPTION OF DRAWINGS

FIG. 1 is a diagram illustrating a compressed fluid supply system according to a first embodiment;

FIG. 2 is a diagram illustrating an example of a relationship between a driving force and a pressure;

FIG. 3 is a diagram illustrating an example of an operation procedure of the compressed fluid supply system according to the first embodiment; and

FIG. 4 is a diagram illustrating a compressed fluid supply system according to a second embodiment.

### DETAILED DESCRIPTION OF THE INVENTION

### First Embodiment

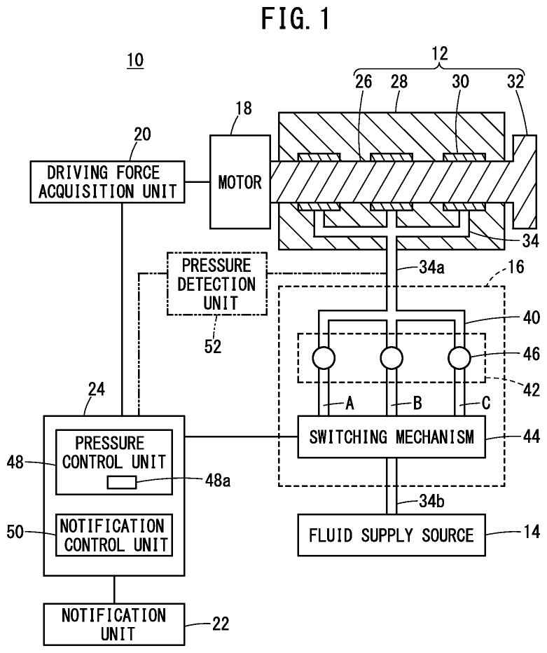

Hereinafter, a compressed fluid supply system 10 according to a first embodiment will be described in detail. FIG. 1 is a diagram illustrating a compressed fluid supply system 10 according to a first embodiment. Here, the compressed fluid supply system 10 includes a spindle 12, a fluid supply source 14, a pressure adjustment unit 16, a motor 18, a driving force acquisition unit 20, a notification unit 22, and a control unit 24. The spindle 12 includes a movable member 26, a fixed member 28, and a support member 30.

The movable member (e.g., shaft) 26 is drivable (rotatable in this case) relative to the fixed member (e.g., housing) 28, and is driven (rotated) by the motor 18. An article holding part 32 is attached to an end of the movable member 26. The article holding part 32 holds an article (for example, a machining target) and rotates together with the movable member 26.

The fixed member 28 has a passage 34 for supplying a compressed fluid from the fluid supply source 14 to the support member 30. The passage 34 is connected to the pressure adjustment unit 16 via a path 34a. The pressure adjustment unit 16 is connected to the fluid supply source 14 via a path 34b. As a result, the compressed fluid is supplied from the fluid supply source 14 to the support member 30 via the path 34b, the pressure adjustment unit 16, the path 34a, and the passage 34.

The support member 30 is, for example, a static pressure bearing, and rotatably supports the movable member 26 using a compressed fluid. More specifically, the support member 30 is provided between the fixed member 28 and the movable member 26, and supports the movable member 26 so as to be rotatable with respect to the fixed member 28 by the compressed fluid supplied from the fluid supply source 14. The rigidity of the support member 30 changes according to the pressure P of the compressed fluid supplied to the support member 30. As the rigidity of the support member 30 increases, the gap between the fixed member 28 and the movable member 26 is less likely to change. As described later, in the present embodiment, the pressure P is changed in accordance with the driving force F of the motor 18 to thereby adjust the rigidity of the support member 30 that supports the movable member 26.

The fluid supply source 14 includes, for example, a compressor (not illustrated), a regulator (not illustrated), and the like. The fluid supply source 14 supplies a compressed fluid to the support member 30 via the pressure adjustment unit 16 and the passage 34. The compressed fluid is a fluid that has been compressed (pressurized). Examples of compressed fluids include compressed gases (e.g., air or nitrogen) or liquids (e.g., lubrication oil).

The pressure adjustment unit 16 adjusts the pressure P of the compressed fluid supplied from the fluid supply source 14 to the support member 30. That is, the pressure adjustment unit 16 adjusts the pressure P of the compressed fluid supplied from the fluid supply source 14 to the pressure adjustment unit 16. The pressure adjustment unit 16 supplies the compressed fluid whose pressure has been adjusted, to the support member 30 via the passage 34. The pressure adjustment unit 16 includes a plurality of compressed fluid supply paths 40, a pressure adjustment mechanism 42, and a switching mechanism 44.

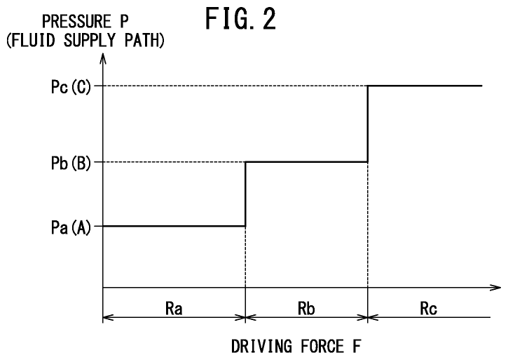

Each of the plurality of compressed fluid supply paths 40 is connected to the fluid supply source 14 via the switching mechanism 44. The plurality of compressed fluid supply paths 40 allow the compressed fluid to be supplied from the fluid supply source 14 to the support member 30. The plurality of compressed fluid supply paths 40 are, for example, pipes, but are not limited to such pipes. In the present embodiment, switching of three compressed fluid supply paths 40 (compressed fluid supply path A, compressed fluid supply path B, and compressed fluid supply path C) is performed. When the compressed fluid supply path A is connected to the fluid supply source 14, the pressure of the fluid supplied from the compressed fluid supply path A to the support member 30 is defined as a pressure Pa. When the compressed fluid supply path B is connected to the fluid supply source 14, the pressure of the fluid supplied from the compressed fluid supply path B to the support member 30 is defined as a pressure Pb. When the compressed fluid supply path C is connected to the fluid supply source 14, the pressure of the fluid supplied from the compressed fluid supply path C to the support member 30 is defined as a pressure Pc. In this example, the pressure Pc is greater than the pressure Pb, and the pressure Pb is greater than the pressure Pa (Pa<Pb<Pc). The pressure Pa, the pressure Pb, and the pressure Pc are shown in FIG. 2 to be described later.

The pressure adjustment mechanism 42 performs adjustment such that the pressures in the three compressed fluid supply paths 40 (the compressed fluid supply path A, the compressed fluid supply path B, and the compressed fluid supply path C) are different from each other. These pressures correspond to the rigidity (stiffness) of the support member 30 supporting the movable member 26. In this embodiment, the pressure adjustment mechanism 42 includes three valves 46 (for example, throttle valves) provided respectively in the three compressed fluid supply paths 40. The three valves 46 are used to regulate the flow rate of the respective three compressed fluid supply paths 40. Thus, the pressures in the three compressed fluid supply paths 40 can be made different from each other. Note that the valves 46 may not be provided in the compressed fluid supply paths 40. For example, the pressures of the fluids supplied from the three compressed fluid supply paths 40 may be different from each other by making the inner diameters of the three compressed fluid supply paths 40 different from each other.

In order to adjust the pressure P of the compressed fluid supplied to the support member 30, the switching mechanism 44 switches the compressed fluid supply paths 40 for connection to the fluid supply source 14. The switching mechanism 44 selects one of the three compressed fluid supply paths 40 and connects the selected compressed fluid supply path 40 to the fluid supply source 14. Thus, the switching mechanism 44 can switch the compressed fluid supply paths 40 for connection to the fluid supply source 14. As described above, the pressures in the plurality of compressed fluid supply paths 40 are different from each other. Therefore, by selecting one of the three compressed fluid supply paths 40 and connecting the selected compressed fluid supply path 40 to the fluid supply source 14, the switching mechanism 44 can adjust the pressure P of the compressed fluid to be supplied to the support member 30.

The driving force acquisition unit 20 acquires information indicating the driving force F of the motor 18 (specifically, the driving force F with which the motor 18 rotates the movable member 26). This information indicates, for example, the torque of the motor 18 or the electric current flowing through the motor 18. The driving force acquisition unit 20 includes, for example, a torque sensor that detects the torque of the motor 18 or a current sensor that detects the electric current supplied to the motor 18. The driving force acquisition unit 20 or the control unit 24 may calculate the driving force F (for example, torque) based on the information indicating the driving force F acquired by the driving force acquisition unit 20.

The notification unit 22 is a sound output device (for example, a speaker), an image display device (for example, a liquid crystal display device or an EL display device), or a light output device (for example, an LED device). The notification unit 22 notifies the operator that the pressure P of the compressed fluid to be supplied to the support member 30 is now being adjusted, using sound, an image, or light.

The control unit 24 includes, for example, hardware (processor) and software (program). The control unit 24 includes a pressure control unit 48 and a notification control unit 50.

The pressure control unit 48 controls the pressure adjustment unit 16 (the switching mechanism 44 in this case) to adjust the pressure P of the compressed fluid to be supplied to the support member 30.

The pressure control unit 48 controls the pressure adjustment unit 16 such that the pressure P of the compressed fluid supplied to the support member 30 becomes higher as the driving force F of the motor 18 becomes greater. The driving force F of the motor 18 is large during rough machining and is small during finish machining, for example. On the other hand, as the pressure P of the compressed fluid to be supplied to the support member 30 increases, the rigidity (stiffness) of the support member 30 supporting the movable member 26 also increases. Therefore, the pressure control unit 48 can increase the rigidity of the support member 30 supporting the movable member 26 during the rough machining and decrease the rigidity during the finish machining.

As a result, stable rough machining and highly-precisely finish machining are facilitated. If the rigidity at the time of rough machining is too small, the gap between the fixed member 28 and the movable member 26 becomes too small, and it may become difficult to perform the machining itself. That is, the spindle 12 may be damaged. On the other hand, if the rigidity at the time of finish machining is too large, large heat generation in the support member 30 occurs. This is because an article (for example, a workpiece to be machined) is rotated at a high speed in the finish machining. In this case, thermal displacement may occur in the spindle 12, and the machining accuracy may decrease.

The pressure control unit 48 includes a table 48a representing the relationship between the driving force F of the motor 18 and the pressure P of the compressed fluid to be supplied to the support member 30 or between the driving force F and the compressed fluid supply path 40 to be selected. FIG. 2 is a diagram illustrating an example of the relationship between the driving force F and the pressure P, and substantially illustrates an example of the table 48a. FIG. 2 shows correspondence relationships between the three drive regions Ra, Rb, and Rc and the pressures Pa, Pb, and Pc. As described above, the pressure Pa is the pressure P of the compressed fluid that is supplied to the support member 30 when the compressed fluid supply path A is connected to the fluid supply source 14, the pressure Pb is the pressure P thereof when the compressed fluid supply path B is connected thereto, and the pressure Pc is the pressure P thereof when the compressed fluid supply path C is connected thereto. The driving force F is divided into the drive region Ra, the drive region Rb, and the drive region Rc. That is, one of the pressure Pa, the pressure Pb, and the pressure Pc (i.e., one of the compressed fluid supply path A, the compressed fluid supply path B, and the compressed fluid supply path C) is selected depending on whether the driving force F is in the driving region Ra, the driving region Rb, or the driving region Rc. For example, when the driving force F is initially within the driving region Rb and thereafter increases and shifts to the driving region Rc, the compressed fluid supply path 40 connected to the fluid supply source 14 is switched from the compressed fluid supply path B to the compressed fluid supply path C. As a result, the pressure P of the compressed fluid supplied to the support member 30 is adjusted from the pressure Pb to the pressure Pc.

Here, as an example, the number of the compressed fluid supply paths 40 is set to three (the compressed fluid supply path A, the compressed fluid supply path B, and the compressed fluid supply path C), and the driving force F is divided into the three drive regions Ra, Rb, and Rc. The number of the compressed fluid supply paths 40 may be two, or four or more, and the driving force F may accordingly be divided into two, or four or more regions. The table 48a may represent the relationship between information indicating the driving force F and the pressures P of the compressed fluid to be supplied to the support member 30 or the relationship between information indicating the driving force F and the compressed fluid supply paths 40 to be selected.

When the pressure control unit 48 controls the pressure adjustment unit 16 to start adjustment of the pressure P of the compressed fluid supplied to the support member 30, the notification control unit 50 controls the notification unit 22 to notify the operator that the pressure P of the compressed fluid supplied to the support member 30 is currently being adjusted. Accordingly, the operator can recognize that the pressure P of the compressed fluid supplied to the support member 30 (that is, the rigidity of the support member 30 supporting the movable member 26) is currently being adjusted.

After the notification control unit 50 causes the notification unit to notify that the adjustment is currently being performed (notification that the adjustment is in progress), the notification control unit 50 causes the notification unit to notify the operator that the adjustment of the pressure P of the compressed fluid supplied to the support member 30 has been completed (notification that the adjustment has been completed). That is, when a predetermined time elapses after the pressure control unit 48 has started adjusting the pressure P, the notification control unit 50 determines that the adjustment of the pressure P of the compressed fluid supplied to the support member 30 has been completed, and causes notification of the completion of the adjustment to be given.

In this embodiment, the notification control unit 50 determines the completion of the pressure adjustment based on elapse of a predetermined time from the start of the adjustment. The notification control unit 50 may determine the completion of the pressure adjustment by using a pressure detection unit 52 indicated by an imaginary line in FIG. 1. The pressure detection unit 52 is provided in the spindle 12 or in the pressure adjustment unit 16, and detects the pressure P of the compressed fluid supplied to the support member 30. The notification control unit 50 determines whether or not the adjustment of the pressure P has been completed, based on the detection signal from the pressure detection unit 52. The notification control unit 50 can determine the completion of the adjustment based on whether or not the detected pressure P of the compressed fluid reaches the selected pressure.

Before starting the adjustment of the pressure P of the compressed fluid supplied to the support member 30, the notification control unit 50 may notify the operator that the adjustment of the pressure P of the compressed fluid supplied to the support member 30 will be started from the present time (notification of the start of the adjustment).

When the notification unit 22 is a speaker, a sound of a first mode (sound indicating the adjustment being in-progress, which will be simply referred to as “adjustment-in-progress sound”) and a sound of a second mode (sound indicating the completion of the adjustment, which will be simply referred to as “completion-of-adjustment sound”) which is different from the first mode can be used respectively for the notification during the adjustment and the notification of the completion of the adjustment. A sound of a third mode (sound indicating the start of the adjustment, which will be simply referred to as “start-of-adjustment sound”) different from the sound of the first mode can be used for the notification of the start of the adjustment. The mode used here means any one of the magnitude (volume) of the sound, the pitch (musical pitch) of the sound, the pattern of the sound, and the output interval of the sound, or a combination thereof. For example, a continuous sound (e.g., “beep”) can be used as the adjustment-in-progress sound, and a single sound “pip” different in volume or pitch from “beep” of the adjustment-in-progress sound can be used as each of the start-of-adjustment sound and the completion-of-adjustment sound. That is, the continuous sound and the two single sounds can be combined to clearly express the transition of the adjustment.

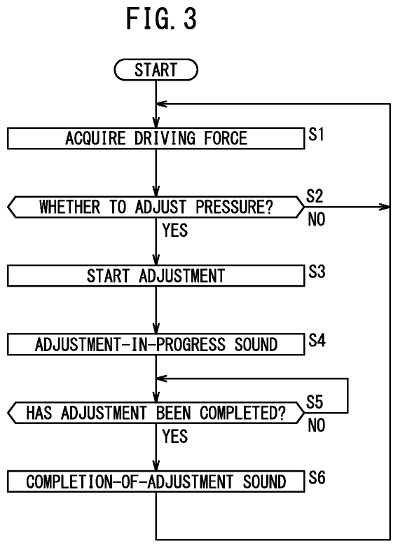

Hereinafter, an operation procedure of the compressed fluid supply system 10 according to the first embodiment will be described. FIG. 3 is a diagram illustrating an example of an operation procedure of the compressed fluid supply system 10 according to the first embodiment. The pressure control unit 48 acquires information indicating the driving force F of the motor 18 using the driving force acquisition unit 20 (step S1). The pressure control unit 48 determines whether or not the pressure P of the compressed fluid supplied to the support member 30 should be adjusted, by referring to the table 48a and based on the acquired information (step S2). For example, when the driving force F is initially within the range of the driving region Rb, the pressure control unit 48 determines whether or not the driving force F subsequently has deviated from the range of the driving region Rb. That the driving force F has deviated from the range of the driving region Rb means that the driving force F is within the range of the driving region Rc or within the range of the driving region Ra.

If the result of the determination in step S2 is YES, the pressure control unit 48 controls the pressure adjustment unit 16 to start adjustment of the pressure P (step S3). That is, the pressure adjustment unit 16 switches the compressed fluid supply paths 40 for connection to the fluid supply source 14, by being controlled by the pressure control unit 48. If the result of the determination in step S2 is NO, the process returns to step S1 and the pressure control unit 48 acquires the information indicating the driving force F again (step S1). The pressure control unit 48 determines whether or not to adjust the pressure P based on the acquired information indicating the driving force F (step S2).

After Step S3, the notification control unit 50 causes the notification unit 22 to output the sound of the first mode (adjustment-in-progress sound) indicating that the pressure P of the compressed fluid supplied to the support member 30 is currently being adjusted (step S4).

Thereafter, the notification control unit 50 determines whether or not the adjustment has been completed (step S5). When determining YES in step S5, the notification control unit 50 causes the notification unit 22 to output the sound of the second mode (completion-of-adjustment sound) indicating that the adjustment of the pressure P has been completed (step S6). Here, when the determination result is NO in step S5, the process returns to step S5. Instead of step S5, the process may return to step S4. Thus, the notification control unit 50 can cause the adjustment-in-progress sound to be continuously output until the completion-of-adjustment sound starts to be output. As described above, the completion of the adjustment can be determined based on elapse of a predetermined time from the start of the adjustment of the pressure P (or based on the pressure P of the compressed fluid detected by the pressure detection unit 52).

As described above, the compressed fluid supply system 10 adjusts the pressure P of the compressed fluid supplied to the support member 30, based on the driving force F of the motor 18 that drives the movable member 26. Thus, the rigidity (stiffness) of the support member 30 supporting the movable member 26 can be controlled in accordance with the driving state of the movable member 26. For example, when the driving force F is large (for example, at the time of rough machining), by increasing the rigidity of the support member 30, stable rough machining can be performed. In addition, when the driving force F is small (for example, at the time of finish machining), by reducing the rigidity of the support member 30, finish machining with high machining accuracy can be performed.

The notification control unit 50 causes the adjustment-in-progress sound and the completion-of-adjustment sound to be output. Accordingly, the operator can easily grasp the state of adjustment of the pressure P of the compressed fluid supplied to the support member 30. As described above, this pressure corresponds to the rigidity of the support member 30 supporting the movable member 26.

For the sake of clarity, the present embodiment has been described based on the compressed fluid supply system 10 having the spindle 12. However, the basic concept of the present embodiment can be applied to a general compressed fluid supply system that drives a movable member 26. The present embodiment does not necessarily assume the presence of the spindle 12.

### Second Embodiment

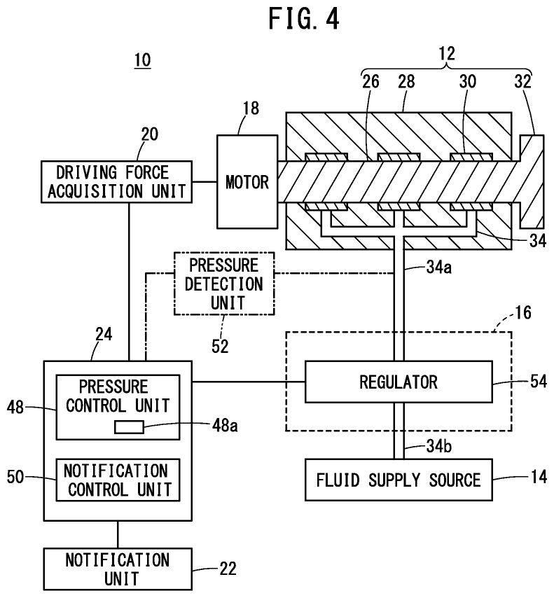

FIG. 4 is a view showing the compressed fluid supply system 10 according to the second embodiment. As shown in FIG. 4, the compressed fluid supply system 10 includes a regulator 54, instead of the plurality of compressed fluid supply paths 40, the pressure adjustment mechanism 42, and the switching mechanism 44 in the first embodiment.

That is, the pressure adjustment unit 16 includes the regulator 54 (for example, an electropneumatic regulator). The pressure control unit 48 controls the regulator 54 to adjust the pressure P of the compressed fluid.

In this case, the table 48a represents a correspondence relationship between the driving force F and the pressure P. Based on the acquired information indicating the driving force F and the table 48a, the pressure control unit 48 instructs the regulator 54 to output the pressure P. The regulator 54 includes, for example, a valve and a pressure detection unit that detects the pressure of the compressed fluid in the vicinity of the support member 30. The regulator 54 opens and closes the valve such that the detected pressure becomes the instructed pressure.

In the first embodiment, the pressure P is adjusted by switching the compressed fluid supply paths 40, and thus the pressure P is changed stepwise as shown in FIG. 2. On the other hand, in the second embodiment, fine adjustment using the regulator 54 is possible. This makes it easy to continuously change the pressure P in accordance with the driving force F.

Also in the second embodiment, similarly to the first embodiment, the completion of the adjustment can be determined based on the elapse of a predetermined time from the start of the adjustment of the pressure P (or based on the pressure of the compressed fluid detected by the pressure detection unit 52). However, the pressure detection unit of the regulator 54 may be used for this determination.

Since the second embodiment is the same as the first embodiment except for the above points, a detailed description thereof will be omitted.

### Modifications

In the first embodiment, the movable member 26 is rotatable with respect to the fixed member 28, and the movable member 26 is rotated by the motor 18. On the other hand, the movable member 26 is slidable (movable) with respect to the fixed member 28 and may be slid by the motor 18. In this case, the motor 18 may be either a rotary motor or a linear motor. The rotary motion of the rotary motor may be converted into a sliding motion to thereby slide the movable member 26. Alternatively, the movable member 26 may be slid by a linear motor.

The driving force acquisition unit 20 acquires information indicating the driving force F. The driving force F means a force with which the motor 18 slides the movable member 26. The driving force acquisition unit 20 may be, for example, any of a force sensor, a torque detection unit, and a current detection unit. The force sensor detects the driving force F of the motor 18 for sliding the movable member 26. The torque detection unit detects the torque of the motor 18. The current detection unit detects the electric current of the motor 18. That is, the movable member 26 can perform driving in a broad sense, relative to the fixed member 28. The driving in a broad sense includes one or both of rotation and sliding. The movable member 26 may perform driving in a broad sense, caused by the motor 18.

Since the modification is the same as the first embodiment except for the above points, a detailed description thereof will be omitted.

The first embodiment, the second embodiment, and the modifications described above can be combined as appropriate. That is, all or part of the configuration of the modification can be applied to the first embodiment and the second embodiment.

### Invention Obtained from the Embodiments

Inventions that can be grasped from the above-described embodiments and the modification will be described below.

[1] The compressed fluid supply system (10) includes: the pressure adjustment unit (16) configured to adjust the pressure (P) of the compressed fluid that is supplied from the fluid supply source (14) to the support member (30), the support member being configured to support the movable member (26) so as to be drivable using the compressed fluid; the driving force acquisition unit (20) configured to acquire the driving force (F) of the motor (18) configured to drive the movable member; and the pressure control unit (48) configured to control the pressure adjustment unit to thereby adjust the pressure of the compressed fluid supplied to the support member, based on the driving force of the motor. With this configuration, the rigidity (stiffness) of the support member supporting the movable member can be adjusted in accordance with the driving force of the motor.

[2] The pressure control unit controls the pressure adjustment unit in a manner so that the pressure of the compressed fluid supplied to the support member becomes higher as the driving force of the motor becomes greater. With this configuration, as the driving force of the motor becomes greater, the rigidity of the support member supporting the movable member can be made higher.

[3] The pressure adjustment unit includes: the plurality of compressed fluid supply paths (40) configured to allow the compressed fluid to be supplied from the fluid supply source to the support member; the pressure adjustment mechanism (42) configured to adjust pressures of the compressed fluid in the plurality of compressed fluid supply paths so as to be different from each other; and the switching mechanism (44) configured to switch the compressed fluid supply paths for connection to the fluid supply source, by being controlled by the pressure control unit. Thus, the pressure of the compressed fluid supplied to the static pressure bearing can be adjusted by switching the compressed fluid supply paths for connection to the fluid supply source.

[4] The pressure adjustment mechanism includes the plurality of throttle valves (46) provided respectively in the plurality of compressed fluid supply paths. With this configuration, the pressures of the compressed fluid in the compressed fluid supply paths can be adjusted differently from one another by means of the plurality of throttle valves.

[5] The pressure adjustment unit includes the regulator (54) configured to adjust the pressure of the compressed fluid supplied to the support member, by being controlled by the pressure control unit. Thus, the pressure of the compressed fluid supplied to the static pressure bearing can be adjusted by using the regulator.

[6] The compressed fluid supply system further includes the notification control unit (50) configured to control the notification unit (22). When the pressure control unit controls the pressure adjustment unit to start adjustment of the pressure of the compressed fluid supplied to the support member, the notification control unit controls the notification unit to notify the operator that the adjustment of the pressure of the compressed fluid supplied to the support member is currently being performed. Thus, the operator can recognize that the pressure of the compressed fluid supplied to the support member is currently being adjusted.

[7] The notification control unit causes the operator to be notified that the adjustment of the pressure of the compressed fluid supplied to the support member has been completed, after notifying that the adjustment is currently being performed. Thus, the operator can recognize that the adjustment has been completed.

[8] The notification control unit determines that the adjustment of the pressure of the compressed fluid supplied to the support member has been completed when a predetermined time has elapsed since the pressure control unit controlled the pressure adjustment unit to start the adjustment of the pressure of the compressed fluid supplied to the support member. Thus, the notification control unit can determine the completion of the adjustment without using a pressure detector.

[9] The compressed fluid supply system further includes the pressure detection unit (52) configured to detect the pressure of the compressed fluid supplied to the support member. The notification control unit determines whether or not the adjustment of the pressure of the compressed fluid supplied to the support member has been completed, based on a detection signal of the pressure detection unit. Accordingly, it is possible to improve the reliability of the determination of the completion of the adjustment by using the pressure detector.

[10] The notification unit is the speaker. The notification control unit causes the notification unit to output the sound of the first mode when the adjustment of the pressure of the compressed fluid supplied to the support member is currently being performed, and causes the notification unit to output the sound of the second mode different from the first mode when the adjustment of the pressure of the compressed fluid supplied to the support member has been completed. Accordingly, the operator can grasp the progress status until the completion of the adjustment by the sound of the first mode and the sound of the second mode.

[11] The notification control unit causes the operator to be notified that the adjustment of the pressure of the compressed fluid supplied to the support member is to be started from a present time, before the adjustment of the pressure of the compressed fluid supplied to the support member is started. With this configuration, the operator can recognize that the adjustment of the pressure of the compressed fluid supplied to the support member is due to be started.

[12] The notification unit is the speaker, and the notification control unit causes the notification unit to output the sound of the third mode different from the sound of the first mode and thereby causes the operator to be notified that the adjustment of the pressure of the compressed fluid supplied to the support member is to be started from the present time. Accordingly, the operator can grasp the progress state from the start of the adjustment by the sound of the first mode and the sound of the third mode.

[13] The support member is the static pressure bearing configured to support the movable member so as to be rotatable or slidable using the compressed fluid. Accordingly, the movable member can be rotatably or slidably supported by the static pressure bearing.

[14] The compressed fluid supply system is a machine tool, and the machine tool includes a spindle (12) including the movable member. Thus, the rigidity of the spindle can be adjusted according to the driving force of the motor.

1. A compressed fluid supply system comprising:
a pressure adjustment unit configured to adjust a pressure of a compressed fluid that is supplied from a fluid supply source to a support member, the support member being configured to support a movable member so as to be drivable using the compressed fluid;
a driving force acquisition unit configured to acquire a driving force of a motor configured to drive the movable member; and
a pressure control unit configured to control the pressure adjustment unit to thereby adjust the pressure of the compressed fluid supplied to the support member, based on the driving force of the motor.

2. The compressed fluid supply system according to claim 1, wherein
the pressure control unit controls the pressure adjustment unit in a manner so that the pressure of the compressed fluid supplied to the support member becomes higher as the driving force of the motor becomes greater.

3. The compressed fluid supply system according to claim 1, wherein
the pressure adjustment unit includes:
a plurality of compressed fluid supply paths configured to allow the compressed fluid to be supplied from the fluid supply source to the support member;
a pressure adjustment mechanism configured to adjust pressures of the compressed fluid in the plurality of compressed fluid supply paths so as to be different from each other; and
a switching mechanism configured to switch the compressed fluid supply paths for connection to the fluid supply source, by being controlled by the pressure control unit.

4. The compressed fluid supply system according to claim 3, wherein
the pressure adjustment mechanism includes a plurality of throttle valves provided respectively in the plurality of compressed fluid supply paths.

5. The compressed fluid supply system according to claim 1, wherein
the pressure adjustment unit includes a regulator configured to adjust the pressure of the compressed fluid supplied to the support member, by being controlled by the pressure control unit.

6. The compressed fluid supply system according to claim 1, further comprising:
a notification control unit configured to control a notification unit,
wherein, when the pressure control unit controls the pressure adjustment unit to start adjustment of the pressure of the compressed fluid supplied to the support member, the notification control unit controls the notification unit to notify an operator that the adjustment of the pressure of the compressed fluid supplied to the support member is currently being performed.

7. The compressed fluid supply system according to claim 6, wherein
the notification control unit causes the operator to be notified that the adjustment of the pressure of the compressed fluid supplied to the support member has been completed, after notifying that the adjustment is currently being performed.

8. The compressed fluid supply system according to claim 7, wherein
the notification control unit determines that the adjustment of the pressure of the compressed fluid supplied to the support member has been completed when a predetermined time has elapsed since the pressure control unit controlled the pressure adjustment unit to start the adjustment of the pressure of the compressed fluid supplied to the support member.

9. The compressed fluid supply system according to claim 7, further comprising:
a pressure detection unit (52) configured to detect the pressure of the compressed fluid supplied to the support member,
wherein the notification control unit determines whether or not the adjustment of the pressure of the compressed fluid supplied to the support member has been completed, based on a detection signal of the pressure detection unit.

10. The compressed fluid supply system according to claim 7, wherein
the notification unit is a speaker, and
the notification control unit causes the notification unit to output a sound of a first mode when the adjustment of the pressure of the compressed fluid supplied to the support member is currently being performed, and causes the notification unit to output a sound of a second mode different from the first mode when the adjustment of the pressure of the compressed fluid supplied to the support member has been completed.

11. The compressed fluid supply system according to claim 6, wherein
the notification control unit causes the operator to be notified that the adjustment of the pressure of the compressed fluid supplied to the support member is to be started from a present time, before the adjustment of the pressure of the compressed fluid supplied to the support member is started.

12. The compressed fluid supply system according to claim 11, wherein
the notification unit is a speaker, and
the notification control unit causes the notification unit to output a sound of a third mode different from the sound of the first mode and thereby causes the operator to be notified that the adjustment of the pressure of the compressed fluid supplied to the support member is to be started from the present time.

13. The compressed fluid supply system according to claim 1, wherein
the support member is a static pressure bearing configured to support the movable member so as to be rotatable or slidable using the compressed fluid.

14. The compressed fluid supply system according to claim 1, wherein
the compressed fluid supply system is a machine tool, and
the machine tool includes a spindle (12) including the movable member.
